(19) United States
(12) Patent Application Publication
(10) Pub. No.: US 2014/0185427 A1
(43) Pub. Date: Jul. 3, 2014

(54) DUAL-RING SWITCH FOR RSTP NETWORKS

(71) Applicant: George A. Ditzel, III, Palatine, IL (US)

(72) Inventor: George A. Ditzel, III, Palatine, IL (US)

(73) Assignee: SCHNEIDER ELECTRIC INDUSTRIES SAS, Rueil Malmaison (FR)

(21) Appl. No.: 14/128,428

(22) PCT Filed: Mar. 30, 2012
(86) PCT No.: PCT/US2012/031381

§ 371 Date: Feb. 27, 2014

Related U.S. Application Data
(60) Provisional application No. 61/502,861, filed on Jun. 30, 2011.

(51) Int. Cl. H04L 12/437

(52) U.S. Cl. CPC H04L 12/437
USPC 370/223

(57) ABSTRACT

A dual-ring computer network architecture for industrial automation systems includes a dual-ring switch for interconnecting two networks, such as Rapid Spanning Tree Protocol (RSTP) networks. The dual-ring switch may provide separate control planes between the two networks but a common data plane between the networks. The system topology may include a main ring and a sub-ring, which creates separate fault regions for isolation. Using this configuration, the standard RSTP practical limit of 32 devices is no longer a limit, as the use of the dual-ring switch provides a mechanism to expand the total number of devices up to 256 while maintaining the network recovery time to within a target of 50 milliseconds. This allows for the use of dual rings using the RSTP protocol on a single switch. In another embodiment, two dual-ring switches are configured in the same sub-ring for redundancy.

This application claims priority to provisional U.S. application No. 61/502,861, filed on Jun. 30, 2011, the entirety of which is hereby incorporated by reference.

### BACKGROUND

In many computer systems, particularly those used for industrial automation and control, network reliability and uptime can be important to the ongoing operation of the underlying service or operation. Oftentimes, it is important that a network failure be promptly isolated and the network immediately restored. Thus, fault isolation and automatic recovery under network failure conditions may be important for higher bandwidth networks and task-critical applications. Even in a typical network failure and recovery scenario, a delay on the order of a few hundred milliseconds can have undesirable consequences.

In a typical fault recovery scenario, when a failure occurs, data traffic is rerouted or switched from a current faulty path to a backup path. Depending on the actual redundancy strategy, the standby or backup data path may be dedicated, may require a physical change in connections, or may be a virtual backup path to the active or primary path. Current software methods for providing redundancy in a network may require that the devices on the network analyze or discover the entire network to determine a backup path.

Rapid Spanning Tree Protocol (RSTP) and Hirschmann HIPER-Ring are two such methods. In both RSTP and Hirschmann HIPER-Ring, the entire network must be discovered before rerouting can be implemented, increasing the downtime of the network for fault recovery. For example, the use of RSTP within a ring network has a practical upper limit of 32 devices in order to continue to provide a network recovery time within 50 milliseconds. In addition to this limited scalability, depending upon the network configuration, the network devices implementing the fault recovery cannot perform normal operations with the other devices on the network during the downtime or recovery period.

Thus, a need exists to provide a reliable and cost-effective solution, particularly for industrial automation systems where reliability and instantaneous fault recovery for larger systems is important.

### SUMMARY

According to one implementation, a dual-ring network architecture is provided. The system may comprise a plurality of network devices configured in a first ring topology using RSTP, a plurality of network devices configured in a second ring topology using RSTP, independent from the first ring, and a first switch device configured as part of both the first ring and second ring. This topology provides a main ring and a sub-ring, which creates separate fault regions for isolation. A dual-ring switch is coupled between the two independent rings. Using this configuration, the standard RSTP practical limit of 32 devices is no longer a problem, as the use of the dual-ring switch provides a mechanism to expand the total number of devices up to 256 while maintaining the network recovery time to within the target of 50 milliseconds.

In accordance with another variation, a dual-ring RSTP switch is provided. The dual-ring switch comprises a first dual-port Ethernet switch fabric for coupling to a plurality of network devices configured in a first ring topology, a second dual-port Ethernet switch fabric for coupling to a plurality of network devices configured in a second ring topology, independent from the first ring, and a processor coupled to both the first and second dual-port Ethernet switch fabrics configured to provide communication between the first ring and second ring. This allows for the use of dual rings using (e.g.) RSTP protocol on a single switch. Moreover, the main ring and sub-rings can each use the RSTP protocol for redundancy.

According to another variation, the dual-ring switch is coupled with another dual-ring switch in the network as a redundant partner, both connected to both the main ring and the same sub-ring. This topology provides protection against a failure of the dual-ring switch itself, preventing a single point of failure in the network. The pair of switches work as a virtual switch, using a subset of the Virtual Router Redundancy Protocol (VRRP) to coordinate.

Hence, in accordance with some variations, a fax recovery lime of 50 ms can be achieved for networks with up to 256 devices, including reconfiguring and transmitting a message to all switches on the ring in the event of a loss of connection in a ring with up to 16 switches. Moreover, the use of multiple fault regions may provide isolation between the devices for additional reliability and uptime.

### BRIEF DESCRIPTION OF THE DRAWINGS

A more complete understanding of the present disclosure may be acquired by referring to the following description in consideration of the accompanying drawings, in which like reference numbers indicate like features, and wherein:

FIG. 1 shows a dual-ring network topology having two sub-rings.

FIG. 2A shows a network topology for a stand-alone operating mode of a dual-ring switch.

FIG. 2B shows a network topology for a redundant operating mode using a pair of dual-ring switches.

FIG. 3 shows another embodiment of a dual-ring network topology having two sub-rings, wherein the second sub-ring uses a pair of dual-ring switches operating in the redundant mode.

FIG. 4 is a simplified block diagram of a dual-ring switch according to one aspect of the disclosure.

FIG. 5A and FIG. 5B are flowcharts showing the operation of the dual-ring switch.

FIG. 6 shows a dual-ring switch operating in a redundant mode, with another dual-ring switch as a redundant partner.

### DETAILED DESCRIPTION

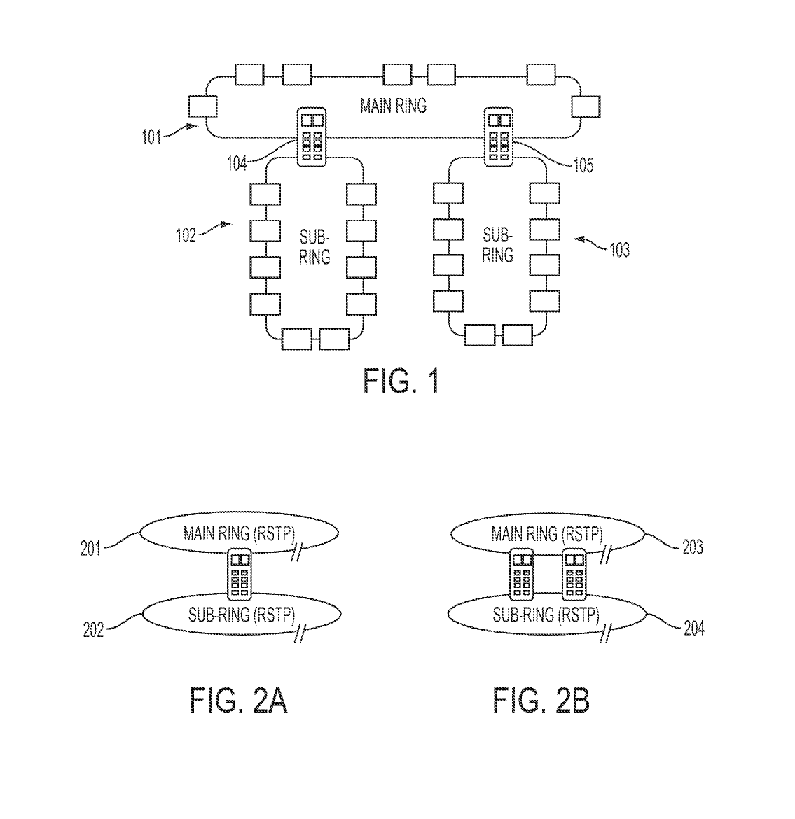

Referring now to FIG. 1, a multiple-ring computer system network topology is shown having a main ring 101 with two sub-rings 102 and 103. The figure shows a number of network devices on the main ring and each sub-ring, which, in an industrial automation system, would typically include a network controller such as a programmable logic controller (PLC) or distributed input/output (DIO) controller, interacting with a number of other devices such as input/output (I/O) devices. A. dual-ring switch (DRS) 104 is coupled to and configured to operate between the main ring and the first sub-ring, and a second dual-ring switch 105 is coupled to and configured to operate between the main ring and the second sub-ring.

Each dual-ring switch supports two network rings, a main ring and a sub-ring. The dual-ring switch operates by keeping the control plane of the two rings separate while integrating the data plane. The control plane is separated by keeping the network control protocols of each network separate. Separate control planes also provide the ability to have separate fault regions, preventing faults from one region propagating into the other region. The main ring is one region, while the sub-ring is another region. The main ring can have many sub-rings attached to it. As can be seen from the topology of FIG. 1, there are three separate fault regions provided, the main ring and the two connected sub-rings 102 and 103.

In one embodiment, both the main ring and the sub-ring are RSTP rings. As explained above, if only one RSTP main ring were used, it would have a practical upper limit of 32 devices in order to continue to provide a network recovery time within 50 milliseconds. Separating the network into a number of independent sub-rings allows for expansion of the total number of devices to 256 while maintaining the network recovery time to within the target of 50 milliseconds. The separate control plane also provides the ability for the sub-ring to have its own RSTP root. This is what allows ring convergence and recovery to occur within 50 milliseconds as they are now processed in parallel and distributed among the main ring and all sub-rings.

FIGS. 2A and 2B show that the dual-ring switch can have two operating modes: standalone and redundant. In the standalone mode (FIG. 2A), a single switch is coupled between the main ring and the sub-ring and configured to operate independently of any other switch. If a loss of connection occurs in the sub-ring network, the DRS will reconfigure the sub-ring and transmit a message to all switches on the main ring.

However, if it is desired to protect against a failure of he DRS itself in the sub-ring, then a redundant operating mode can be used as shown in FIG. 2B. Here, the dual-ring switch is coupled with another dual-ring switch as a redundant partner, both connected to both the main ring and the same sub-ring as shown. This configuration prevents having a single point of failure in the network, as the pair of switches work as a virtual switch.

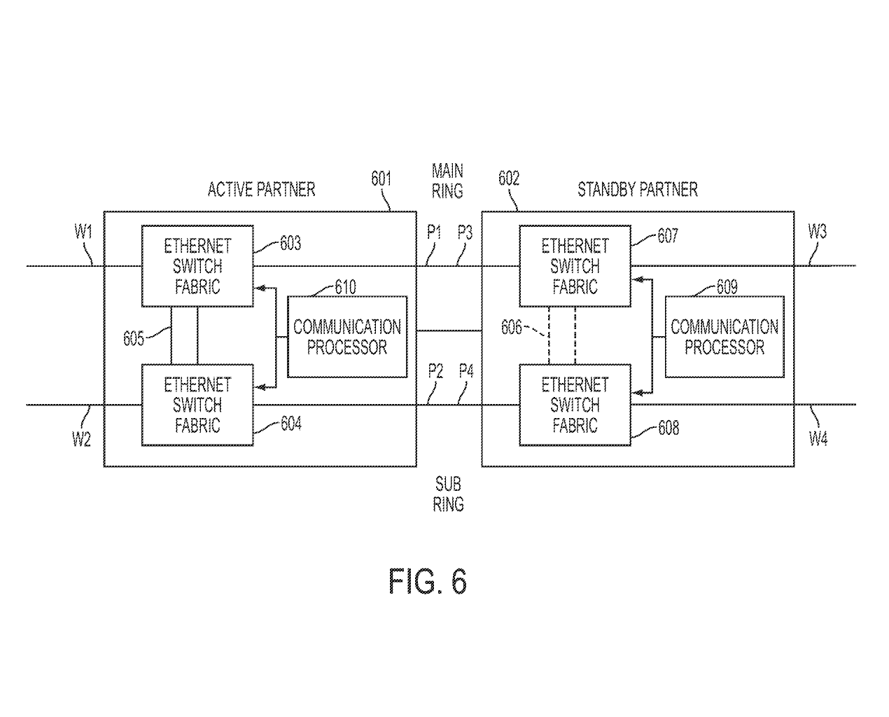

This can occur with the switches using a subset of the Virtual Router Redundancy Protocol (VRRP) to coordinate. Information about VRRP is publicly available, as it is an Internet Engineering Task Force (IETF) standard. Further details regarding one implementation are provided below in connection with FIG. 6.

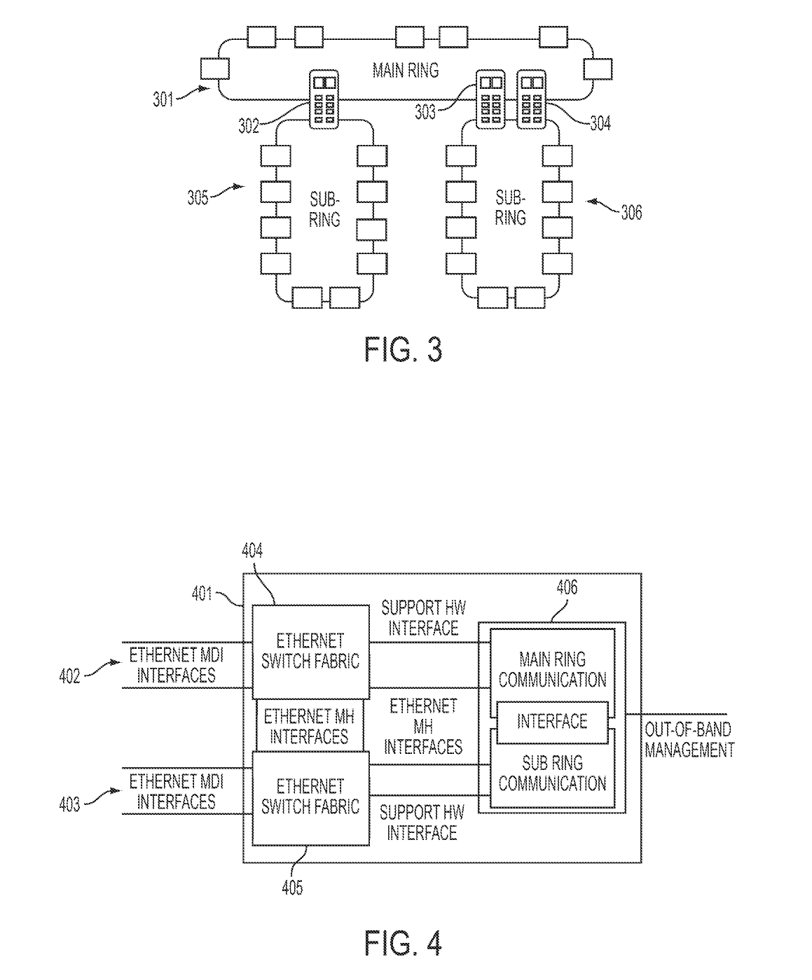

FIG. 3 shows another embodiment of a dual-ring RSTP network topology having two RSTP sub-rings 305 and 306, wherein the second sub-ring uses a pair of dual-ring switches 303 and 304 operating in the redundant mode. Again, it can be seen that there are three separate fault regions (as opposed to a single fault region with a single RSTP main ring), and that the second sub-ring has two dual-ring switches, each operating in the redundant mode.

Referring now to FIG. 4, a simplified block diagram of a dual-ring switch 401 is shown. The dual-ring switch can be composed of two Ethernet switch fabrics 404 and 405 and a communication core processor 406 that handles communication between the fabrics. One switch fabric interconnects with the main ring 402, while the other switch fabric interconnects with the sub-ring 403. The switch fabrics are interconnected to provide data intercommunication.

The communication core processor 406 may comprise a dual-core processor allowing parallel operation of the main ring and the sub-ring. The main ring communication block may include a firmware image in one processor core dedicated to processing the Rapid Spanning Tree Protocol (RSTP) messages on the main Ethernet ring, while the sub-ring communication block is a firmware image in another processor core dedicated to processing the RSTP messages on the Ethernet sub-ring. In one embodiment, the Ethernet switch fabric may comprise a Marvell Linkstreet 6165 or 6351 switch chip. The dual-core processor may comprise an ST Micro SPEAr600 with a dual-core interface support between the main ring communication and sub-ring communication firmware.

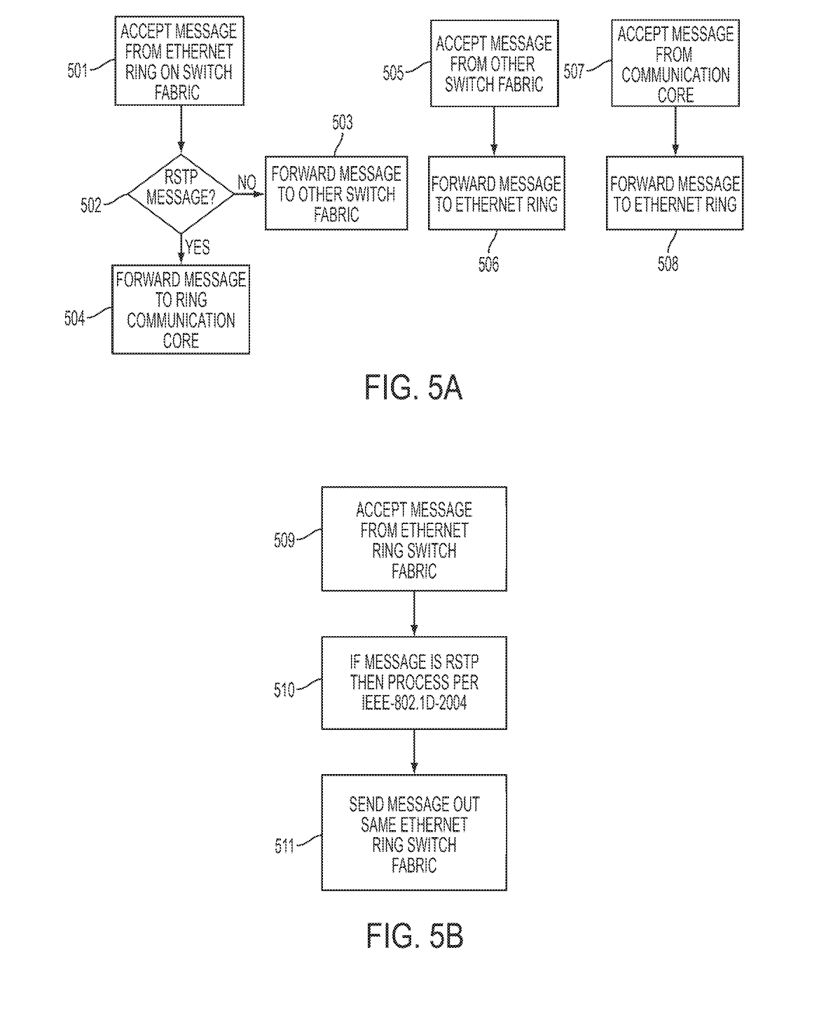

FIG. 5A is a flowchart shoaling the operation of the Ethernet switch fabric of the dual-ring switch of FIG. 4. This switch fabric flowchart describes the operation of either the upper switch fabric coupled to the Ethernet media dependent interface (MDI) of the main ring or of the sub-rings. All three subroutines shown at the left, middle, and right side of FIG. 5A run concurrently. In the subroutine flowchart at the left, in step 501, a message is accepted from the corresponding Ethernet ring at the switch fabric port. Next, in step 502, the message is tested to decide whether or not it is an RSTP message. If it is an RSTP message, the lower path is taken (step 504), where the switch fabric forwards the RSTP message to the ring communication core for further processing, as described in conjunction with FIG. 5B below. if it is not an RSTP message, step 503 is taken, where the switch fabric forwards the non-RSTP message to the other switch fabric.

In the subroutine flowchart in the middle of FIG. 5A, in step 505, if the switch fabric receives a non-RSTP message from another switch fabric, it simply forwards the message on to the Ethernet ring (step 506). This is done in order to have the dual-ring switch pass-through non-RSTP messages that are intended to be communicated to the other ring.

In the subroutine flowchart at the right of FIG. 5A, in step 507, if the switch fabric accepts an RSTP message from the communication core (as will be described below with FIG. 5B), it forwards the message to its associated Ethernet ring (step 508). This is done in order to prevent the dual-ring switch from communicating the RSTP messages to the other ring.

FIG. 5B is a flowchart showing the operation of the communication core processor of the dual-ring switch of FIG. 4. This operation also runs concurrently with the operation of the switch fabrics. in step 509, upon acceptance of a message from an Ethernet ring switch fabric, the communication core processor determines if the message is an RSTP message and then processes the message per the well-known IEEE 802.1D-2004 standard (step 510). This would include detecting the fault in the network, notifying the other devices on the ring of the fault by sending a topology change notice, and implementing the fault recovery procedures. More detailed information on these steps can be obtained from the publicly available IEEE 802.1D-2004 standards.

Upon completion of this RSTP message processing, the communications core will then send a message out via the same Ethernet ring switch fabric, i.e., via the same ring the message came in on (step 511).

Turning now to FIG. 6, further details of one variation of a redundant operating mode using two dual-ring switches (i.e., FIG. 2B) are shown. An active partner (dual-ring switch 601) and a standby partner (dual-ring switch 602) can be coupled together in both a main ring (top of FIG. 6) and sub-ring (bottom of FIG. 6). Active partner 601 includes first and second Ethernet switch fabrics (ESFs) 603 and 604, which are controlled by communication processor 610. Similarly, standby partner 602 includes ESFs 607 and 608, controlled by communication processor 609.

Active partner 601 is coupled to the rings through working ports W1 and W2, and standby partner 602 is coupled to the rings through ring working ports W3 and W4. The ESE 603 of active partner 601 is coupled to ESE 607 of standby partner 602 via redundant partner ports P1 and P3, respectively. Similarly, ESE 604 of active partner 601 is coupled to ESE 608 of standby partner 602 via redundant partner ports P2 and P4, respectively.

The Ethernet switch fabrics 603 and 604 of the active partner 601 are coupled via. ports 605, whereas the port connections between the main ring ESE and the sub-ring ESF within the standby partner are blocked (indicated by dashed lines 606 in standby partner 602).

In one variation, the partner closest to the root switch in the main ring can be chosen as the active partner (i.e. left side of FIG. 6). The other partner (element 602 in FIG. 6) will be deemed the standby partner.

If a partner is designated the root switch of the Rapid Spanning Tree Protocol (RSTP), then it will start up as the active partner. The other partner will start up as standby and backup root switch.

Both the active and standby switches participate in the respective RSTP protocols (main-ring and sub-ring) except for the following case: Neither of the partner ports (main ring ports P1 and P3, and sub-ring ports P2 and P4) can be blocked.

In that case the blocked port will be moved to the standby switch's working port the respective ring (main ring port W3 and sub-ring port W4).

In one or more variations, fault detection and recovery may occur as follows.

First, suppose that here is a fault on the main ring. Three separate scenarios are addressed below.

(A) If there is a break in the active partner working port (WI) connection, the active partner will initiate a topology change by generating an RSTP Topology Change Notice (TCN) on its partner port (P1), then proceed to flush only the main ring ESF 603. The standby partner will accept the RSTP TCN on its partner port (P3), forward the RSTP TCN on its working port (WS), then proceed to flush only its main ring ESE 607. The main ring should then recover through the RSTP TCN processing of other members on the ring. All sub-ring traffic will continue to flow through the active partner.

(B) If there is a break in the standby partner working port (W3) connection, the standby partner will initiate a topology change by generating an RSTP Topology Change Notice (TCN) on its partner port (PS), then proceed to flush only its main ring ESF 607. The active partner will accept the RSTP TCN on its partner port (P1), forward the RSTP TCN on its working port (W1), then proceed to flush only its main ring ESF 603. The main ring should then recover through the RSTP TCN processing of other members on the ring. All sub-ring traffic will continue to flow through the active partner.

(C) If there is a break in partner port connections (ports P1 or P3), the active partner will initiate a topology change by generating an RSTP Topology Change Notice (TCN) on its working port (W1), and then proceed to flush only its main ring ESF 603. The standby partner will initiate a topology change by generating an RSTP Topology Change Notice (TCN) on its working port (W3), and then proceed to flush only the main ring ESF 607. The main ring should then recover through the RSTP TCN processing of other members on ring. All sub-ring traffic will continue to flow through the active partner.

Second, suppose that there is a failure of the active partner. In some variations, the standby partner periodically generates a heartbeat message out one of the partner ports (i.e. P3) which is intended to traverse through the active partner by its partner ports (i.e. ports P1 and P2). The standby partner should receive the heartbeat message on its other partner port (i.e. P4) within a specified period of time. If the standby partner does not receive the heartbeat message within the specified period of time, the standby partner will initiate an RSTP Topology Change Notice on both the main ring and the sub-ring, and activate the connection between its ESFs 607 and 608 (i.e., activating the dashed lines 606 in FIG. 6). The standby partner will then proceed to become the active partner. All sub-ring traffic will now flow through the new active partner.

Third, considering the pair as a root in the main ring or sub-ring, three possible scenarios are addressed below.

(A) If there is a break in an active partner working port (W1 or W2) connection, the active partner will initiate a topology change by generating an RSTP Topology Change Notice (TCN) on its partner port (P1 or P2), then proceed to flush only the appropriate ESF. The standby partner will accept the RSTP TCN on its partner port (P3 or P4), forward the RSTP TCN on its working port (W3 or W4), then proceed to flush only the appropriate ESF. The main-ring should then recover through the RSTP TCN processing of other members on the ring. All sub-ring Traffic will continue to flow through the Active Partner.

(B) If there is a break in the standby partner working port (W3 or W4) connection, the standby partner will initiate a topology change by generating an RSTP Topology Change Notice (TCN) on its partner port (P3 or P4), then proceed to flush only the appropriate ESF. The active partner will accept the RSTP TCN on its partner port (P1 or P2), forward the RSTP TCN on its working port (W1 or W2), then proceed to flush only the appropriate ESF. The main-ring should then recover through the RSTP TCN processing of other members on the ring. All sub-ring traffic will continue to flow through the active partner.

(C) If there is a break in partner port connections, the active partner will initiate a topology change by generating an RSTP Topology Change Notice (TCN) on its working port (W1 or W2), and then proceed to flush only the main-ring ESF 603. The standby Partner will initiate a Topology Change by generating a RSTP Topology Change Notice (TCN) on its working port (W3 or W4), and then proceed to flush only the Main-Ring ESF. The main ring should then recover through the RSTP TCN processing of other members on the ring. All sub-ring traffic will continue to flow through the active partner.

The functions and steps described above may be implemented by hardware and/or by software stored in tangible computer-readable media (e.g., a memory) and executed by various computing devices or apparatus, such as a server computer including one or more processors programmed with software.

The divisions between functional blocks in the figures are merely illustrative, and the physical division of computing devices and other equipment may be different from the functional division. Moreover, some or all of the functional blocks may be combined or further subdivided functionally and/or physically.

Unless otherwise explicitly stated, steps of method claims (and corresponding functional elements) herein should not be limited to being performed in the order in which they are recited.

The above-disclosed subject matter is to be considered illustrative, and not restrictive, and the appended claims are intended to cover all such modifications, enhancements, and other embodiments, which fall within the true spirit and scope of the disclosure. Thus, to the maximum extent allowed by law, the scope is to be determined by the broadest permissible interpretation of the following claims and their equivalents, and shall not be restricted or limited by the foregoing detailed description.

What is claimed is:

1. A dual-ring Ethernet network system comprising:
a plurality of network devices configured in a first ring topology;
a plurality of network devices configured in a second ring topology, independent from the first ring; and
a first switch device configured as part of both the first ring and second ring.

2. The system of claim 1, further comprising a second switch device configured as part of both the first ring and second ring and configured to operate in a redundant mode with the first switch device.

3. The system of claim 1, wherein the first switch device is configured to:
determine whether the devices on the second ring are operational; and
inform the network devices on the first ring whether the second ring is operational.

4. The system of claim 1, wherein the first and second ring topologies both operate according to Rapid Spanning Tree Protocol (RSTP).

5. The system of claim 4, wherein the first ring topology comprises more than 32 devices.

6. The system of claim 1, wherein he network devices configured on c second ring include a plurality of I/O devices.

7. The system of claim 1, wherein the first switch device is configured to operate separate control planes between the first ring topology and the second ring topology but an integrated data plane between the first ring topology and the second ring topology.

8. The system of claim 2, wherein the first and second switch devices are interconnected, and wherein the second switch device is configured to operate with blocked ports between the first ring topology and the second ring topology when operating in the redundant mode.

9. The system of claim 8, wherein the second switch is configured to unblock the blocked ports upon detecting failure of the first switch device.

10. The system of claim 2, wherein the second switch device is configured to send heartbeat messages to the first switch device and, upon determining that no response to a heartbeat message is received, configuring itself to be in an active, non-redundant mode.

11. The system claim 1, wherein the first switch device comprises:
a first dual-port Ethernet switch fabric for coupling to the plurality of network devices configured in the first ring topology using RSTP;
a second dual-port Ethernet switch fabric for coupling to the plurality of network devices configured in the second ring topology using RSTP; and
a processor coupled to both the first and second dual-port Ethernet switch fabrics configured to provide communication between the first ring and second ring.

12. A dual-ring switch comprising:
a first dual-port Ethernet switch fabric for coupling to a plurality of network devices configured in a first ring topology;
a second dual-port Ethernet switch fabric for coupling to a plurality of network devices configured in a second ring topology, independent from the first ring;
a processor coupled to both the first and second dual-port Ethernet switch fabrics configured to provide communication between the first ring and second ring.

13. The dual-ring switch of claim 12, wherein at least one of the first and second ring topologies operates according to RSTP.

14. The dual-ring switch of claim 12, wherein the processor is configured to detect a failure of another dual-ring switch to which it is interconnected and, in response, configuring itself to be in an active, non-redundant mode.

15. The dual-ring switch of claim 12, wherein the first and second dual-port Ethernet switch fabrics are configured to have blocked ports preventing data from traversing between the first and second ring topologies when the dual-ring switch is acting in a redundant mode, and unblocked ports permitting data to traverse between the first and second ring topologies when the dual-ring switch is in an active mode.

16. The dual-ring switch of claim 12, wherein the processor is configured to receive a message and:
responsive to determining that the message is a network configuration message, forward the message to the first ring topology; and
responsive to determining that the message is not a network configuration message, forward the message to the second ring topology.

17. A method of managing a fault in a computer network, the method comprising:
providing a dual-ring network having a dual-ring switch coupled between the two rings;
detecting a fault in one of the rings;
sending a topology change notice; and
reconfiguring the network in response to the topology change notice.

18. The method of claim 17, wherein at least one of the two rings operates according to RSTP.

19. The method of claim 17, wherein the dual-ring switch is configured to provide separate control planes between the two rings but an integrated data plane between the two rings.

20. The method of claim 17, wherein the dual-ring switch is configured to operate with internally blocked ports between a first Ethernet switch fabric and a second Ethernet switch fabric when operating in a redundant mode, and unblocked ports between the first Ethernet switch fabric and second Ethernet switch fabric when operating in an active mode.

21. The method of claim 17, further comprising providing a second dual-ring switch and interconnecting the second dual-ring switch with the dual-ring switch to operate in a redundant mode.
